(19) United States
(12) Patent Application Publication
(10) Pub. No.: US 2010/0110042 A1
(43) Pub. Date: May 6, 2010

(54) INPUT/OUTPUT IMAGE PROJECTION SYSTEM OR THE LIKE

(75) Inventor: Gene Frantz, Sugar Land, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/493,865

(22) Filed: Jun. 29, 2009

Related U.S. Application Data
(60) Provisional application No. 61/076,536, filed on Jun. 27, 2008.

(51) Int. Cl. G06F 3/042; H04N 9/31

(52) U.S. Cl. 345/175; 348/744; 348/E09.025

(57) ABSTRACT

An input/output device has a light source in optical communication with a digital mirror device (DMD) special light modulator for projecting an image and an image sensor in optical communication along a shared optical path with the same spatial light modulator for receiving an image.

This is a Non-Provisional Application of U.S. Application Ser. No. 61/076,536, filed on Jun. 27, 2008, the entirety of which is incorporated herein by reference.

### BACKGROUND

Many screen applications need to have a touch sensitive screen. In DLP projection, this may not be easy to do. This disclosure provides a way to do this using a “one pixel” camera capability in parallel with the DLP video output.

### SUMMARY

In a product that needs both video output and object recognition, an apparatus comprises a single pixel sensor and one or more light source(s) (e.g., red, green, blue LEDs, or white LED, etc.). A digital micromirror device (DMD) has movable mirrors that are controlled to change positions in such a way as to interleave the RGB light sources with the sensor input. This allows video to be displayed while, at the same time, an input signal can be accepted to do image recognition, etc. In an embodiment, the system may be used in sensor mode only to take pictures. In one arrangement, the RGB LEDs are used to aid in the picture taking by turning on while the sensor is looking for each of the colors.

### BRIEF DESCRIPTION OF THE DRAWINGS

FIGS. 1-6 illustrate embodiments and applications of the invention.

### DETAILED DESCRIPTION OF EXAMPLE EMBODIMENTS

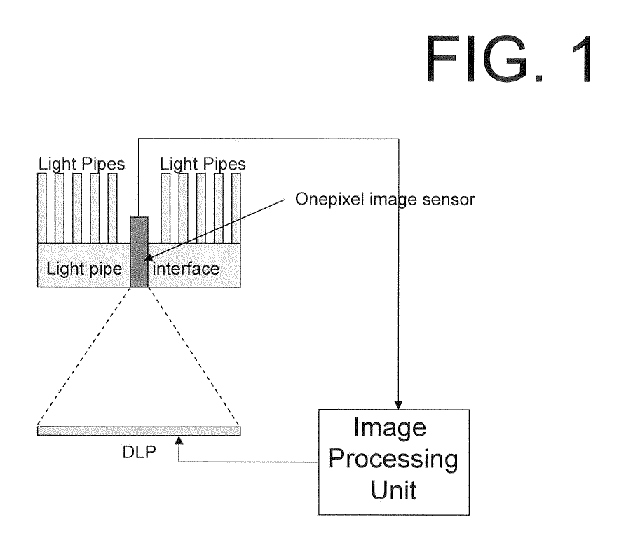

An embodiment of a method in accordance with the invention uses digital micromirrors (see FIG. 1). In such method: 1) Images are piped into light pipe interface. At least one light pipe for each image. 2) Light is focused down onto the movable mirrors of a digital micromirror device (DMD), such as a DLPtm light imaging device available from Texas Instruments, Dallas, Tex. 3) The DMD reflects the light to the one pixel sensor. 4) The image processing unit randomly turns on and off minors, captures a pixel for each different random mirror configuration, separates the multiple images, and processes each image separately.

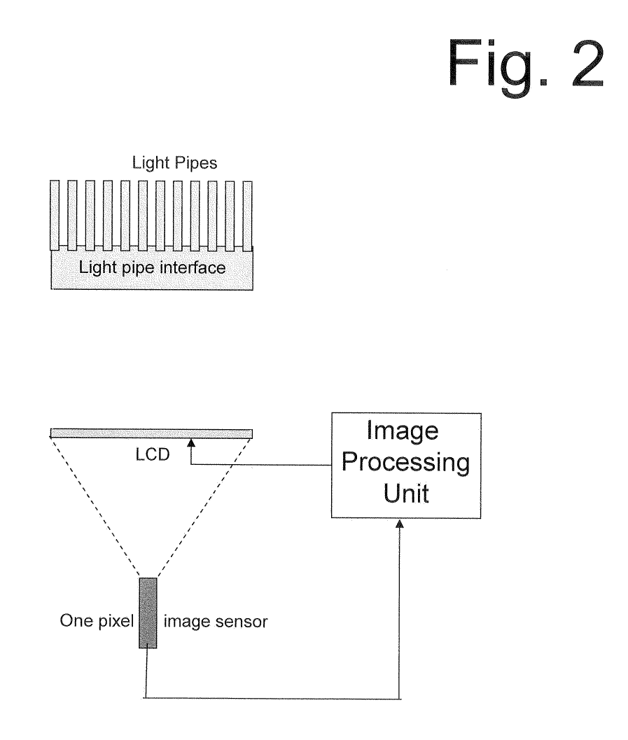

Another embodiment of a method of the invention (see FIG. 2) uses liquid crystal displays (LCDs). 1) Images are piped into the light pipe interface. At least one light pipe for each image. 2) Light is focused down onto the LCD. 3) The LCD selectively passes the light to the one pixel sensor. 4) The image processing unit randomly turns on and off pixels on the LCD to let half of the pixels to pass the image mirrors, captures a pixel for each different random configuration, separates the multiple images, and processes each image separately.

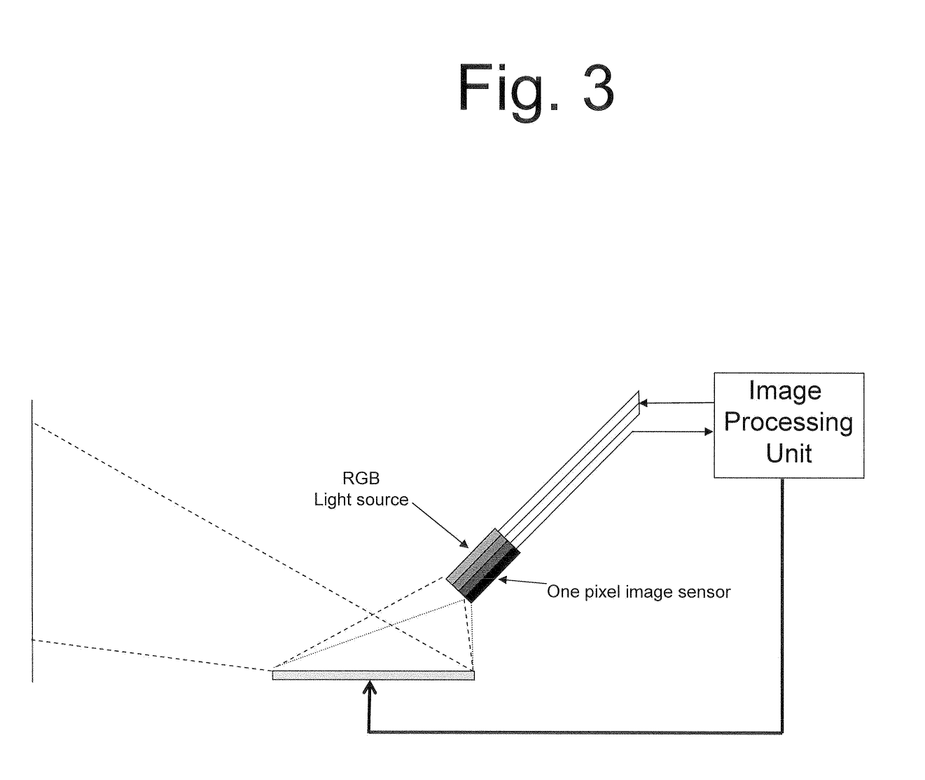

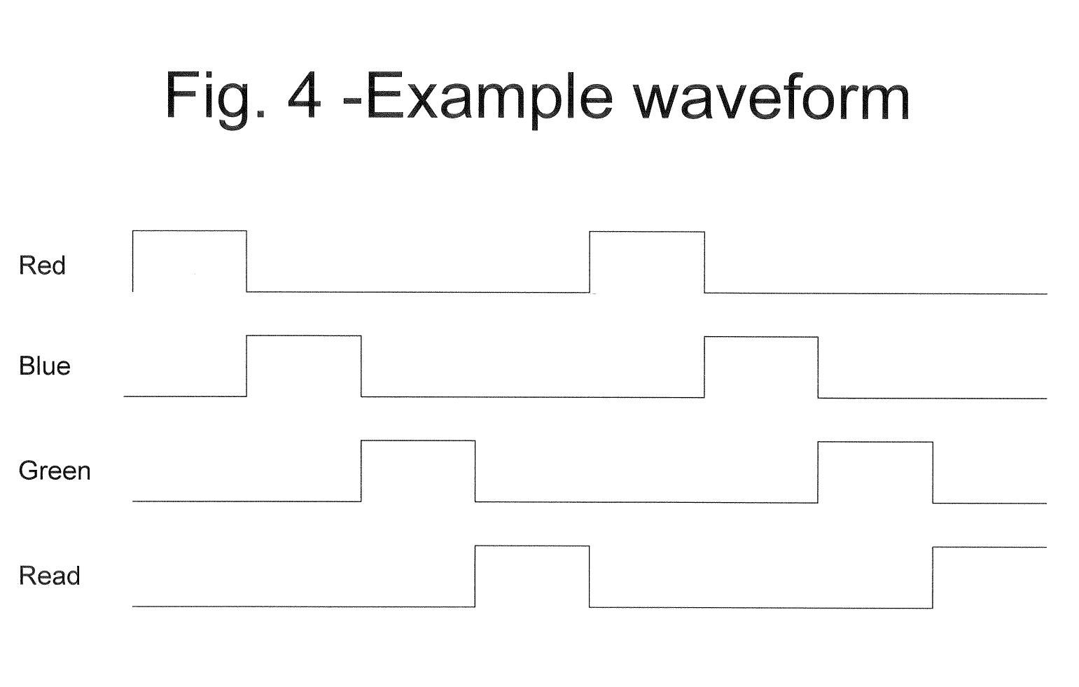

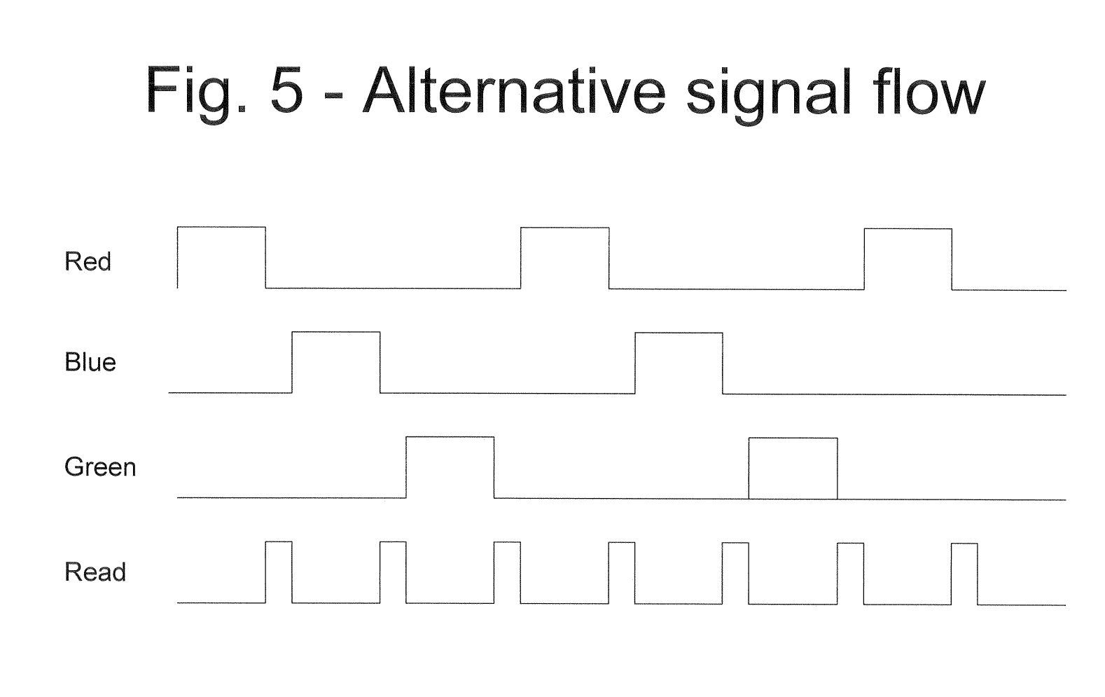

Used as an input/output device, the image processing unit simultaneously drives RGB light sources in synchronous order to DLP pixel, and receives image data from “single pixel” sensor (see FIG. 3). FIGS. 4 and 5 illustrate examples of RGB waveform and read signals.

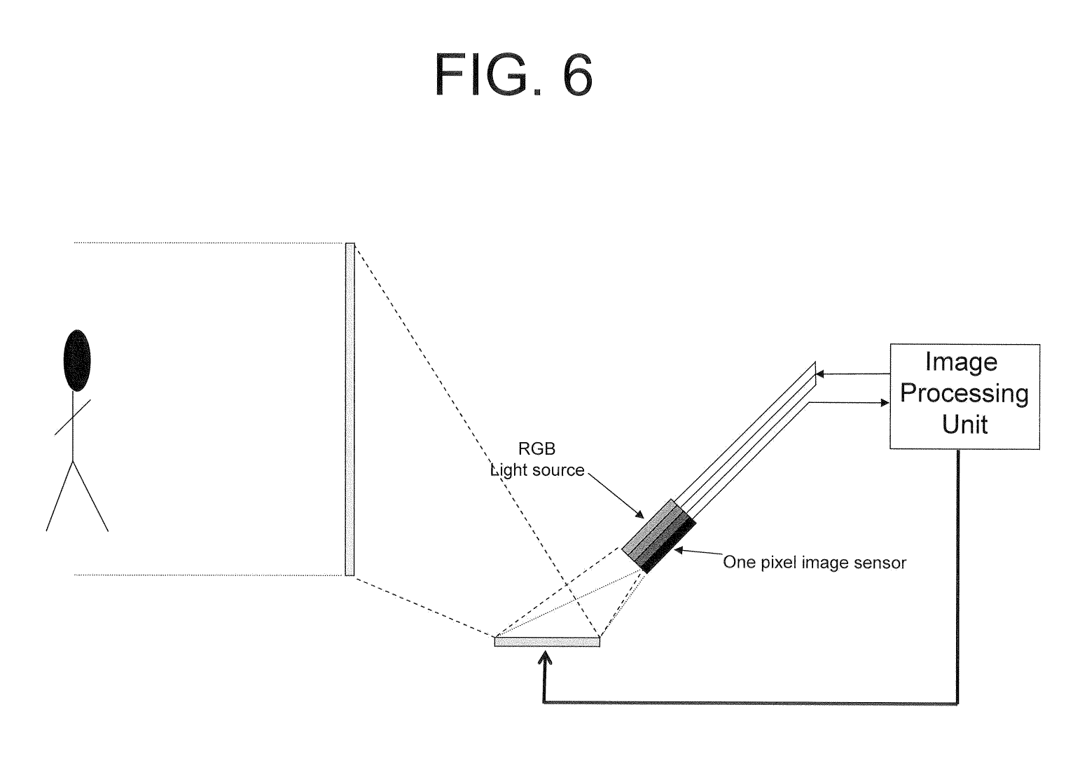

FIG. 6 illustrates an application for showing a movie (output) with a field of projection in one spatial direction, and observing a viewer (input) in a field of view area in another spatial direction.

As described, a DMD is simultaneously used for input and output in a video application. The described embodiments enable a simple DLPtm projector system to also do simultaneous object recognition with minimal added cost (the one pixel sensor). Once this could be done it could be used for touch sensitive screen emulation, motion detection while projecting information, games where the game machine needs to display and read at the same time (example would be to play Tic Tac Toe with someone—or another machine), and communicate between two different machines.

DMD's can also be employed for an embodiment that provides a multi-input optical sensor using a one pixel camera.

In many systems with optical sensors (e.g., imagers, light sensors, etc), cost is an issue. Each sensor must be interfaced and interpreted independently before being introduced to the processing system. In accordance with an embodiment of this aspect of the invention, multiple “light pipes” may be used to transmit the image from where the camera would normally be, to a conversion block. In the conversion block, the light pipes are positioned such that they direct the image to a portion of a DMD device. The DMD device is then driven to randomly send a composite version of the images to a one pixel sensor. This random data is used by a microprocessor (or DSP, etc) to reconstruct each of the images in its memory system. Based on the reconstruction the processor acts appropriately to the inputted images. This approach enables the use of a few or even only one pixel in the imager, making the system inexpensive and more manageable. It allows for the use of a relatively low cost DMD. It reduces or eliminates the need for optically pure glass; it can still function even if not all of the deformable minor elements of the DMD are good; and the device may be implemented as a relatively slow device. An advantage is that a few or even a single sensor may be used to handle multiple image inputs. Publications of Rice University research on a single pixel camera are incorporated herein by reference.

Similar principles may be applicable to an advertising tool embodiment, wherein an image is projected on a screen and read passively by various individuals. With the ability to do video I/O using a DMD-based system, the “seeing” area could be determined to be much larger than the “viewing” area. That means that if the “seeing” area of the screen were, say 10 feet by 10 feet, the actual projected picture might only be 3 feet by 3 feet. With this difference the projected picture could be in the middle of the “seeing area”. As a viewer begins to show up in the “seeing” area, the picture can be moved, changed or altered otherwise to capture the attention of the viewer. Once captured, it could become interactive with the viewer to better meet the interests of the viewer. Using object recognition the viewer can motion to the system to get it to do what the viewer wishes.

With the DMD I/O solution, the area observed by the I/0 system may be significantly larger than the area on which a picture is projected. This allows for many innovations on how to interact with the viewing public. This allows visual advertising to be interactive. Obviously other aspects can be seen. For example, the number of viewers can be counted along with other statistics of how long they lingered, their interests, etc.

Those skilled in the art will appreciate that other embodiments may be implemented based on the same principles and teachings.

What is claimed is:

1. The apparatus and method as show and described.
